(19) United States
(12) Patent Application Publication
(10) Pub. No.: US 2007/0172691 A1
(43) Pub. Date: Jul. 26, 2007

(54) Electroless coating methods for depositing silver-tungsten coatings, kits and products

(76) Inventors: Yosi Shacham-Diamond, Zichon-Yaakov (IL); Nathan Croitoru, Kfar Saba (IL); Alexandra Inberg, Herzeliya (IL)

Correspondence Address: DARBY & DARBY P.C., P.O. BOX 770, Church Street Station, New York, NY, 10008-0770, US

(21) Appl. No.: 10/597,626

(22) PCT Filed: Feb. 4, 2004
(86) PCT No.: PCT/IL04/00110

§ 371 Date: Dec. 1, 2006

(51) Int. Cl. B05D 1/18; B32B 15/00

(52) U.S. Cl. 428/663; 427/437; 427/443.1; 427/430.1

(57) ABSTRACT

Materials, methods and kits are disclosed for providing an electrolessly-deposited tarnish-resistant silver-tungsten coated object, the electrolessly-deposited tarnish-resistant silver-tungsten coated object comprising: an object; a silver-tungsten coating on the object, wherein the silver-tungsten coating has a substantially constant reflectivity of more than 90% at 500 nm after exposure of the coated object to ambient air for a time period of at least one week.

### FIELD OF THE INVENTION

The present invention relates generally to metallic deposition materials and processes, and more specifically to materials and processes for metallic electroless deposition.

### BACKGROUND OF THE INVENTION

Silver (Ag) is known as a precious metal due to its high reflectivity (=96%) and electrical conductivity (1.59×10⁻⁶Ω·cm), and relative scarcity.

Due to its qualities, silver is one of the materials which is used in numerous products and industries such as, but not limited to, photography, tableware, ornament, mirror, jewelry, coins and medals, and medical products and industries. There are numerous potential future applications in bioengineering and microelectronics too. Together with those positive properties, several drawbacks make silver applications limited. One of the most important disadvantages of silver is its tendency to tarnish due to contact with sulfur-containing materials in the ambient atmosphere or in packaging. These materials allow the formation of silver sulfide on the silver surface.

Furthermore, in high humidity or salty atmospheres the silver interaction with oxygen and or chloride ions allows the formation of silver oxides and/or chlorides. In the all cases, the silver surface loses its luster and develops grey-black or yellow tarnish. The color of the tarnish depends on the thickness and nature of the contaminant. Furthermore, sterling silver objects can get green stains from the copper therein. These qualities greatly reduce the value of products manufactured from silver. Additionally, tarnishing and corrosion of silver reduces the reliability of electrical applications (reduced conductivity) or for optical applications (reduced reflectivity).

Several different approaches have been employed to overcome the tarnishing problems of silver. For example, electrolytic passivation by alloying with copper in sterling silver (92.5% silver and 7.5% copper) is not completely tarnish-free. Low tarnish silver alloys are further described in U.S. Pat. No. 5,882,441 and U.S. Pat. No. 5,817,195 to Davitz.

Lacquer or polymer tarnishing resistant surface coatings deposited on the silver object act as a barrier for the contact with the surrounding atmosphere. This barrier is not reliable and stable over time. Finishes to a silver surface to improve tarnish resistance are described in U.S. Pat. No. 4,006,026 to Dahms.

Curing the tarnished product using proprietary solutions or abrasives, which remove oxidized parts of the silver surface renders the surface more sensitive to chemical reactions.

Storage of household items and jewelry in cabinets or bags may reduce, but does not eliminate the tarnishing problem.

A relatively new method of high quality and long term reliability silver protection was developed for industrial mirrors, microelectronics and other applications. This method is directed to silver encapsulation between two other films, which prevent its tarnishing. This method is limited by the difficulties to produce high quality films (homogenous, constant thickness, without pinholes) and expensive. A coating composition for preparing an anticorrosive mirror is described in U.S. Pat. No. 6,613,818 to Sakatoku et al.

In order to remove tarnish from a silver object, several methods have been developed. Electrolytic methods for removal of silver tarnish from silver articles are described in U.S. Pat. No. 4,353,786 to de Jager and in U.S. Pat. No. 5,478,450 to Buck.

Kits for cleaning jewelry and other small parts are disclosed in U.S. Pat. Nos. 5,876,513 and 6,076,538 to Frankson and in 6,231,258 to Kingsley.

There still remains an urgent need to develop novel materials and methods for improving the reliability and stability of a silver object exposed to air. There is also a need to further develop practical materials and methods for removing tarnish and restoring the properties of a silver surface.

### SUMMARY OF THE INVENTION

It is an object of some aspects of the present invention to provide silver objects with improved surface reliability and tarnish resistance.

It is a further object of some aspects of the present invention to provide materials and methods for restoring the properties of a silver surface.

In preferred embodiments of the present invention, improved materials and processes are provided for the electroless deposition of silver tungsten

There is thus provided in accordance with a preferred embodiment of the present invention, a tarnish-resistant coated object including:
an object,
a silver-tungsten coating on the object, wherein the silver-tungsten coating has a reflectivity of more than 40% at 700 nm after exposure of the coating to air at 200° C. for a time period of at least one hour.

Also, in accordance with a preferred embodiment of the present invention, the time period is at least one day.

Furthermore, in accordance with a preferred embodiment of the present invention, the time period is at least one week.

Additionally, in accordance with a preferred embodiment of the present invention, the silver-tungsten coating is adapted to provide a substantially metallic luster for a time period of at least one week.

Further, in accordance with a preferred embodiment of the present invention, wherein the silver-tungsten coating is adapted to provide a substantially metallic luster for at least one month.

Yet further, in accordance with a preferred embodiment of the present invention, wherein the silver-tungsten coating is adapted to provide a substantially metallic luster for at least one year.

Also, in accordance with a preferred embodiment of the present invention, the coating includes less than five atomic percent of sulfur after the time period. Preferably, the time period is at least one day, more preferably, at least one week, yet more preferably at least one month, and most preferably at least one year.

Additionally, in accordance with a preferred embodiment of the present invention, the coating includes less than one atomic percent of sulfur after the time period. Preferably, the time period is at least one day, more preferably, at least one week, yet more preferably at least one month, and most preferably at least one year.

Furthermore, in accordance with a preferred embodiment of the present invention, the coating includes less than 0.1 atomic percent of sulfur.

Additionally, in accordance with a preferred embodiment of the present invention, the coating includes less than 0.01 atomic percent of sulfur.

Further, in accordance with a preferred embodiment of the present invention, the coating includes less than 0.001 atomic percent of sulfur.

Yet further, in accordance with a preferred embodiment of the present invention, the coating includes less than 0.1 atomic percent of sulfur after at least one week.

Additionally, in accordance with a preferred embodiment of the present invention, the coating includes less than 0.1 atomic percent of sulfur after at least one month.

Further, in accordance with a preferred embodiment of the present invention, the coating includes less than 0.1 atomic percent of sulfur after at least one year.

Furthermore, in accordance with a preferred embodiment of the present invention, the coating includes less than one atomic percent of oxygen after the time period. Preferably, the time period is at least one day, more preferably, at least one week, yet more preferably at least one month, and most preferably at least one year.

Additionally, in accordance with a preferred embodiment of the present invention, the coating includes less than 0.1 atomic percent of oxygen after the time period. Preferably, the time period is at least one day, more preferably, at least one week, yet more preferably at least one month, and most preferably at least one year.

Further, in accordance with a preferred embodiment of the present invention, the coating includes less than 0.01 atomic percent of oxygen after the time period.

Yet further, in accordance with a preferred embodiment of the present invention, the coating includes less than 0.01 atomic percent of oxygen after at least one week.

Also, in accordance with a preferred embodiment of the present invention, the coating includes less than 0.01 atomic percent of oxygen after at least one month.

Additionally, in accordance with a preferred embodiment of the present invention, the coating includes less than 0.01 atomic percent of oxygen after at least one year.

Also, in accordance with a preferred embodiment of the present invention, the coating includes less than one atomic percent of chlorine after the time period. Preferably, the time period is at least one day, more preferably, at least one week, yet more preferably at least one month, and most preferably at least one year.

Furthermore, in accordance with a preferred embodiment of the present invention, the coating includes less than 0.1 atomic percent of chlorine after the time period. Preferably, the time period is at least one day, more preferably, at least one week, yet more preferably at least one month, and most preferably at least one year.

Additionally, in accordance with a preferred embodiment of the present invention, the coating includes less than 0.01 atomic percent of chlorine after the time period. Preferably, the time period is at least one day, more preferably, at least one week, yet more preferably at least one month, and most preferably at least one year.

Also, in accordance with a preferred embodiment of the present invention, a change in an electrical resistivity measurement of the coating is less than five percent over the time period. Preferably, the time period is at least one day, more preferably, at least one week, yet more preferably at least one month, and most preferably at least one year.

Furthermore, in accordance with a preferred embodiment of the present invention, a change in an electrical resistivity measurement of the coating is less than one percent over the time period. Preferably, the time period is at least one day, more preferably, at least one week, yet more preferably at least one month, and most preferably at least one year.

Additionally, in accordance with a preferred embodiment of the present invention, a change in an electrical resistivity measurement of the coating is less than 0.1 percent over the time period. Preferably, the time period is at least one day, more preferably, at least one week, yet more preferably at least one month, and most preferably at least one year.

Also, in accordance with a preferred embodiment of the present invention, the object is selected from an ornamental object, a piece of jewelry, an optical object, a coin, a medal, an electrical object, a kitchen object and a military object.

Furthermore, in accordance with a preferred embodiment of the present invention the object includes sterling silver.

Additionally, in accordance with a preferred embodiment of the present invention, the object includes silver plate.

Further, in accordance with a preferred embodiment of the present invention, the object includes fine silver (100% silver).

Furthermore, in accordance with a preferred embodiment of the present invention, the silver-tungsten coating is less than ten microns thick.

Additionally, in accordance with a preferred embodiment of the present invention, the silver-tungsten coating is less than three microns thick.

Also, in accordance with a preferred embodiment of the present invention, the silver-tungsten coating is less than one micron thick.

Furthermore, in accordance with a preferred embodiment of the present invention, the silver-tungsten coating is less than 500 nm thick.

Additionally, in accordance with a preferred embodiment of the present invention, the silver-tungsten coating is less than 200 nm micron thick.

Furthermore, in accordance with a preferred embodiment of the present invention, the silver-tungsten coating is provided by electroless deposition from an aqueous composition including:
a soluble source of silver ions,
a soluble source of tungsten ions,
a reducing agent, and
at least one additive.

There is thus also provided in accordance with another preferred embodiment of the present invention, a method for providing a tarnish-resistant silver-tungsten coated object including:
mixing a first aqueous solution with a second aqueous solution so as to provide an active silver tungsten electroless deposition solution, and
immersing an object in the active electroless deposition solution for a time period sufficient to provide a tarnish-resistant silver tungsten coated object,

wherein the tarnish-resistant silver tungsten coated object has a reflectance of more than 0.6 at 700 nm after a time period of at least one hour of exposure of the tarnish-resistant silver tungsten coated object to ambient air.

Also, in accordance with a preferred embodiment of the present invention, the first solution includes a reducing agent.

Further, in accordance with a preferred embodiment of the present invention, the reducing agent is hydrazine hydrate.

Yet further, in accordance with a preferred embodiment of the present invention, the first solution includes a chelator.

Still further, in accordance with a preferred embodiment of the present invention, the chelator is EDTA.

Also, in accordance with a preferred embodiment of the present invention, the second solution includes a soluble source of silver ions and a soluble source of tungsten ions.

Further, in accordance with a preferred embodiment of the present invention, the method comprises plating a metallic object. Optionally, the metallic object is a silver object.

Still further, in accordance with a preferred embodiment of the present invention, the silver object is selected from an ornamental object, a piece of jewelry, an optical object, a coin, a medal, an electrical object, a kitchen object and a military object.

Additionally, in accordance with a preferred embodiment of the present invention, the silver object includes sterling silver.

Further, in accordance with a preferred embodiment of the present invention, the silver object includes silver plate.

Yet further, in accordance with a preferred embodiment of the present invention, the object includes fine silver (100% silver).

Also, in accordance with a preferred embodiment of the present invention, the object is a non-metallic object.

Further, in accordance with a preferred embodiment of the present invention, the non-metallic object includes at least one of the following materials: a plastic, a polymer, a ceramic material, a cellulose-based material, an inorganic material, an organic material and a fabric.

There is thus also provided in accordance with another preferred embodiment of the present invention, a kit for providing a tarnish-resistant silver-tungsten coated object including:
a first receptacle adapted to house a first
aqueous solution,
a first aqueous solution,
a second receptacle adapted to house a second aqueous solution and further adapted to house an object,
a second aqueous solution, and
an instruction for:
   (i) pouring the first solution into the second solution in the second receptacle so as to provide an active silver tungsten electroless deposition solution, and
   (ii) immersing the object in the active silver tungsten electroless deposition solution for a period of time sufficient to provide a tarnish-resistant silver tungsten coated object.

Further, in accordance with a preferred embodiment of the present invention, the first aqueous solution includes a reducing agent.

Yet further, in accordance with a preferred embodiment of the present invention, the reducing agent is hydrazine hydrate.

Also, in accordance with a preferred embodiment of the present invention, the first aqueous solution includes a chelator.

Additionally, in accordance with a preferred embodiment of the present invention, the chelator is EDTA.

Further, in accordance with a preferred embodiment of the present invention, the second aqueous solution includes includes a soluble source of silver ions and a soluble source of tungsten ions.

Furthermore, in accordance with a preferred embodiment of the present invention, the first receptacle is substantially opaque.

Additionally, in accordance with a preferred embodiment of the present invention, the second receptacle is substantially opaque.

There is thus also provided in accordance with another preferred embodiment of the present invention, a kit for providing an electrolessly-deposited metal coated object including:
a first receptacle adapted to house a first
aqueous solution,
a first aqueous solution,
a second receptacle adapted to house a second aqueous solution and further adapted to house an object,
a second aqueous solution, and
an instruction for:
   (i) pouring the first solution into the second solution in the second receptacle so as to provide an active electroless metal deposition solution, and
   (ii) immersing the object in the active an active electroless metal deposition solution for a period of time sufficient to provide a metal coated object.

There is thus also provided in accordance with another preferred embodiment of the present invention, electroless plating composition including an aqueous solution for electrolessly plating a surface, including:
a soluble source of silver ions,
a soluble source of tungsten ions,
a reducing agent,
at least one additive, and
a polymer adapted to induce filling of at least one of:
   a substantially vertical trench of more than 300 nm depth: and
   a substantially horizontal gap of more than 200 nm width, on the surface, and
wherein the plating composition is adapted to electrolessly deposit a corrosion-free conformal layer of silver tungsten on the surface, wherein the layer is from about 0.05 to around 10 microns thick.

Also, in accordance with a preferred embodiment of the present invention, the polymer is a polyethylene glycol (PEG).

Additionally, in accordance with a preferred embodiment of the present invention, the PEG is PEG 1500.

Furthermore, in accordance with a preferred embodiment of the present invention, the PEG is PEG 400.

Further, in accordance with a preferred embodiment of the present invention, the composition provides a layer that is less than five microns thick.

Yet further, in accordance with a preferred embodiment of the present invention, the layer is less than three microns thick.

Still further, in accordance with a preferred embodiment of the present invention, the layer is less than one micron thick.

Also, in accordance with a preferred embodiment of the present invention, the layer is less than 0.5 micron thick.

Additionally, in accordance with a preferred embodiment of the present invention, the layer is less than 200 nm micron thick.

There is thus also provided in accordance with another preferred embodiment of the present invention, a tarnish-resistant coated object including:
an object,
a silver-tungsten coating on the object, wherein the silver-tungsten coating has a substantially constant reflectivity of more than 90% at 500 nm after exposure of the coated object to ambient air for a time period of at least one week.

Also, in accordance with a preferred embodiment of the present invention, the time period is at least one month.

Additionally, in accordance with a preferred embodiment of the present invention the time period is at least one year.

Further, in accordance with a preferred embodiment of the present invention, the silver-tungsten coating is adapted to provide a substantially metallic luster for a time period of at least one week. Preferably, the time period is at least one month, and more preferably, at least one year.

Yet further, in accordance with a preferred embodiment of the present invention, the coating includes less than five atomic percent of sulfur after the time period. Preferably, the time period is at least one month, and more preferably, at least one year.

Also, in accordance with a preferred embodiment of the present invention, the coating includes less than one atomic percent of sulfur after the time period. Preferably, the time period is at least one month, and more preferably, at least one year.

Additionally, in accordance with a preferred embodiment of the present invention, the coating includes less than 0.1 atomic percent of sulfur after the time period. Preferably, the time period is at least one month, and more preferably, at least one year.

Also, in accordance with a preferred embodiment of the present invention, the coating includes less than 0.01 atomic percent of sulfur after the time period. Preferably, the time period is at least one month, and more preferably, at least one year.

Also, in accordance with a preferred embodiment of the present invention, the coating includes less than 0.001 atomic percent of sulfur after the time period.

Preferably, the time period is at least one month, and more preferably, at least one year.

Further, in accordance with a preferred embodiment of the present invention, the time period is at least one month.

Yet further, in accordance with a preferred embodiment of the present invention, the time period is at least one year.

Also, in accordance with a preferred embodiment of the present invention, the coating includes less than one atomic percent of oxygen after the time period.

Preferably, the time period is at least one month, and more preferably, at least one year.

Additionally, in accordance with a preferred embodiment of the present invention, the coating includes less than 0.1 atomic percent of oxygen after the time period. Preferably, the time period is at least one month, and more preferably, at least one year.

Moreover, in accordance with a preferred embodiment of the present invention, the coating includes less than 0.01 atomic percent of oxygen after the time period. Preferably, the time period is at least one month, and more preferably, at least one year and most preferably at least two years.

Furthermore, in accordance with a preferred embodiment of the present invention, the coating includes less than one atomic percent of chlorine after the time period. Preferably, the time period is at least one month, and more preferably, at least one year and most preferably at least two years.

Also, in accordance with a preferred embodiment of the present invention, the coating includes less than 0.1 atomic percent of chlorine after the time period. Preferably, the time period is at least one month, and more preferably, at least one year and most preferably at least two years.

Furthermore, in accordance with a preferred embodiment of the present invention, the coating includes less than 0.01 atomic percent of chlorine after the time period. Preferably, the time period is at least one month, and more preferably, at least one year and most preferably at least two years.

Moreover, in accordance with a preferred embodiment of the present invention, a change in an electrical resistivity measurement of the coating is less than five percent over the time period. Preferably, the time period is at least one month, and more preferably, at least one year and most preferably at least two years.

Furthermore, in accordance with a preferred embodiment of the present invention, a change in an electrical resistivity measurement of the coating is less than one percent over the time period. Preferably, the time period is at least one month, and more preferably, at least one year and most preferably at least two years.

Also, in accordance with a preferred embodiment of the present invention, a change in an electrical resistivity measurement of the coating is less than 0.1 percent over the time period. Preferably, the time period is at least one month, and more preferably, at least one year and most preferably at least two years.

Additionally, in accordance with a preferred embodiment of the present invention, the tarnish-resistant coated object is selected from an ornamental object, a piece of jewelry, an optical object, a coin, a medal, an electrical object, a kitchen object and a military object.

Also, in accordance with a preferred embodiment of the present invention, the tarnish-resistant coated object includes sterling silver.

Additionally, in accordance with a preferred embodiment of the present invention, the tarnish-resistant coated includes silver plate.

Further, in accordance with a preferred embodiment of the present invention, the tarnish-resistant coated object includes fine silver (100% silver).

There is thus also provided in accordance with another preferred embodiment of the present invention, keep-clean coated piece of jewelry including:
a piece of jewelry,
a silver-tungsten alloy coating on the piece of jewelry, wherein the silver-tungsten alloy coating is adapted to prevent discoloration of the piece of jewelry after exposure of the keep-clean coated piece of jewelry to ambient air for a time period of at least one week.

Preferably, the time period is at least one month, and more preferably, at least one year and most preferably at least two years.

Further, in accordance with a preferred embodiment of the present invention, the keep-clean coated piece of jewelry includes sterling silver.

Furthermore, in accordance with a preferred embodiment of the present invention, the keep-clean coated piece of jewelry includes silver plate.

Yet further, in accordance with a preferred embodiment of the present invention, the keep-clean coated piece of jewelry includes fine silver (100% silver).

Yet further, in accordance with a preferred embodiment of the present invention, the keep-clean coated piece of jewelry has less than a 5% increase in light absorbance in a range of incident light of 400-700 nm after at least one week of exposure to ambient air.

Moreover, in accordance with a preferred embodiment of the present invention, keep-clean coated piece of jewelry is adapted not to discolor a garment.

Also, in accordance with a preferred embodiment of the present invention, the keep-clean coated piece of jewelry is adapted not to discolor skin.

There is thus also provided in accordance with another preferred embodiment of the present invention, an electroless plating composition for preventing discoloration of a metallic object including an aqueous electroless plating solution, including:
a soluble source of silver ions,
a soluble source of tungsten ions,
a reducing agent,
at least one additive, and
wherein the plating composition is adapted to electrolessly deposit a layer of silver-tungsten on the metallic object so as to provide a silver-tungsten plated metallic object such that the silver-tungsten plated metallic object has less than a 5% increase in light absorbance in a range of incident light at 400-700 nm after exposure to ambient air for a time period of at least one week.

There is thus also provided in accordance with yet another preferred embodiment of the present invention, an electroless plating composition for keeping a metallic object clean, including an aqueous electrolessly plating solution, including:
a soluble source of silver ions,
a soluble source of tungsten ions,
a reducing agent,

at least one additive, and

wherein the plating composition is adapted to electrolessly deposit a layer of silver-tungsten on the metallic object so as to provide a keep-clean silver-tungsten plated metallic object, and wherein the composition further is adapted to provide the silver-tungsten plated metallic object with a shiny metallic luster after exposure to ambient air for a time period of at least one week. Preferably, the time period is at least one month, and more preferably, at least one year and most preferably at least two years.

There is thus also provided in accordance with another preferred embodiment of the present invention, an electroless plating composition for providing a water-wear piece of silver jewelry, the electroless plating composition including an aqueous electrolessly plating solution, including:
a soluble source of silver ions,
a soluble source of tungsten ions,
a reducing agent,

at least one additive, and

wherein the electroless plating composition is adapted to electrolessly deposit a layer of silver-tungsten on a piece of silver jewelry so as to provide a water-wear piece of silver jewelry, and wherein the electroless plating composition is further adapted to substantially prevent discoloration of the water-wear piece of jewelry after exposure of the water-wear piece of jewelry to water after a time period of at least one week. Preferably, the time period is at least one month, and more preferably, at least one year and most preferably at least two years.

There is thus also provided in accordance with yet another preferred embodiment of the present invention, a water-wear piece of silver jewelry including:
a piece of silver jewelry,
a silver-tungsten alloy coating on the piece of silver jewelry, wherein the silver-tungsten alloy coating is adapted to prevent discoloration of the water-wear piece of jewelry after exposure to water after a time period of at least one week. Preferably, the time period is at least one month, and more preferably, at least one year and most preferably at least two years.

Also, in accordance with a preferred embodiment of the present invention, the water is sea water.

Further, in accordance with a preferred embodiment of the present invention, the water is swimming pool water.

Moreover, in accordance with a preferred embodiment of the present invention, the water is municipal water.

Also, in accordance with a preferred embodiment of the present invention, the water-wear piece of silver jewelry includes sterling silver.

Furthermore, in accordance with a preferred embodiment of the present invention, the water-wear piece of silver jewelry includes silver plate.

Additionally, in accordance with a preferred embodiment of the present invention, the water-wear piece of silver jewelry includes fine silver (100% silver).

There is thus also provided in accordance with another preferred embodiment of the present invention, a method for providing a silver ternary metal layer on a surface, including:
electrolessly plating the surface in an electroless plating composition for a sufficient time to plate the surface with a silver tungsten molybdenum layer.

There is thus also provided in accordance with yet another preferred embodiment of the present invention, method for providing a silver ternary metal layer on a surface, including:
electrolessly plating the surface in an electroless plating composition for a sufficient time to plate the surface with a silver tungsten rhenium layer.

There is thus also provided in accordance with another preferred embodiment of the present invention, a silver tungsten molybdenum electroless plating composition, including:
a soluble source of silver ions,
a soluble source of tungsten ions,
a soluble source of molybdenum,
a reducing agent, and
at least one additive.

There is thus also provided in accordance with a further preferred embodiment of the present invention, a silver tungsten rhenium electroless plating composition, including:
a soluble source of silver ions,
a soluble source of tungsten ions,
a soluble source of rhenium,
a reducing agent, and
at least one additive.

The present invention will be more fully understood from the following detailed description of the preferred embodiments thereof, taken together with the drawings, in which:

### BRIEF DESCRIPTION OF THE DRAWINGS

FIG. 1a is a graph of the reflectance of silver-tungsten coated objects (filled circle, 2.1% tungsten, and unfilled triangle, 3.2% atomic percent tungsten) and a pure silver object (unfilled rhombus) as a function of the wavelength of incident light, in accordance with a preferred embodiment of the present invention;

FIG. 1b is a graph of the reflectance of silver-tungsten coated objects (filled circle, 2.1% tungsten, and unfilled triangle 3.2% atomic percent tungsten) and a pure silver object (unfilled rhombus) as a function of the wavelength of incident light after the objects were annealed for one hour in air at 200° C., in accordance with a preferred embodiment of the present invention;

FIG. 2a is a photograph image of a pure silver object following an accelerated tarnishing test at 250° C. in air for three hours, in accordance with a preferred embodiment of the present invention;

FIG. 2b is a photograph image of a silver tungsten coated (250 nm) object following an accelerated tarnishing test at 250° C. in air for three hours, in accordance with a preferred embodiment of the present invention;

FIG. 2c is a photograph image of a silver tungsten coated (500 nm) object following an accelerated tarnishing test at 250° C. in air for three hours, in accordance with a preferred embodiment of the present invention;

FIG. 3a is a cross-sectional image of a silver-tungsten coating in trenches, plated from an electroless silver-tungsten solution comprising polyethylene glycol-1500 (PEG-1500), in accordance with preferred embodiments of the present invention;

FIG. 3b is a cross-sectional image of a silver-tungsten coating in trenches, plated from an electroless silver-tungsten solution comprising PEG-400, in accordance with preferred embodiments of the present invention;

FIGS. 4a and 4b are exploded schematic illustrations of a kit for electrolessly plating silver tungsten on a small object, in accordance with a preferred embodiment of the present invention;

FIG. 5 is a flowchart describing the method of employment of the kit of FIGS. 4a and 4b in the steps of electrolessly plating silver tungsten on a small object, in accordance with a preferred embodiment of the present invention;

FIG. 6 is an exploded schematic illustration of a kit for electrolessly plating silver tungsten on a large object, in accordance with a preferred embodiment of the present invention;

FIG. 7 is a flowchart describing the method of employment of the kit of FIG. 6 in the steps of electrolessly plating silver tungsten on a large object, in accordance with a preferred embodiment of the present invention; and

FIGS. 8A-C, which are images of 1) a piece of bulk silver (left column); 2) a piece of bulk silver with a 300 nm layer of silver tungsten (middle column); and 3) a piece of bulk silver with a 500 nm layer of silver tungsten (right-hand column) after accelerated tests for tarnishing in a sulfur-containing atmosphere, in accordance with a preferred embodiment of the present invention.

### DETAILED DESCRIPTION OF PREFERRED EMBODIMENTS

Various silver objects with improved surface reliability and tarnish resistance were prepared as follows. Silver-tungsten films were deposited from a silver nitrate base solution with hydrazine hydrate as the reducing agent (see Table 1). Sodium tungstate was added into the electroless deposition bath as a source of tungsten for preparing silver tungsten layers. The concentration of sodium tungstate in the solution was 0.006-0.03M. Ammonia and acetic acid were used to complex the metal-ions and, at the same time, supported the working pH to the range of 10.0-10.6 as an ammonium-acetate buffer. The electroless deposition solution operated at room temperature. An example of electroless deposition bath composition is presented in Table 1.

TABLE 1
The composition ot an electroless Ag(W)
deposition solution.

| | CONCENTRATION, |
|---|---|
| Component | M |
| AgNO₃ | 0.03 |
| NH₄OH (25%) | 1.22 |
| CH₃COOH | 0.5 |
| N₂H₂ | 0.1 |
| sodium saccharin | < 0.001 |
| Na₂WO₄ | 0.006 − 0.03 |

Minute quantities of additives (typically less than 0.001 M), known in the art, were introduced for improving the brightness and softness of the deposit. Examples of additives include but are not limited to surfactants, such as sodiumdodecyl sulfate, RE-610 and Triton X-100, brighteners such as sodium saccharin and levelling agents such as bezotriazole.

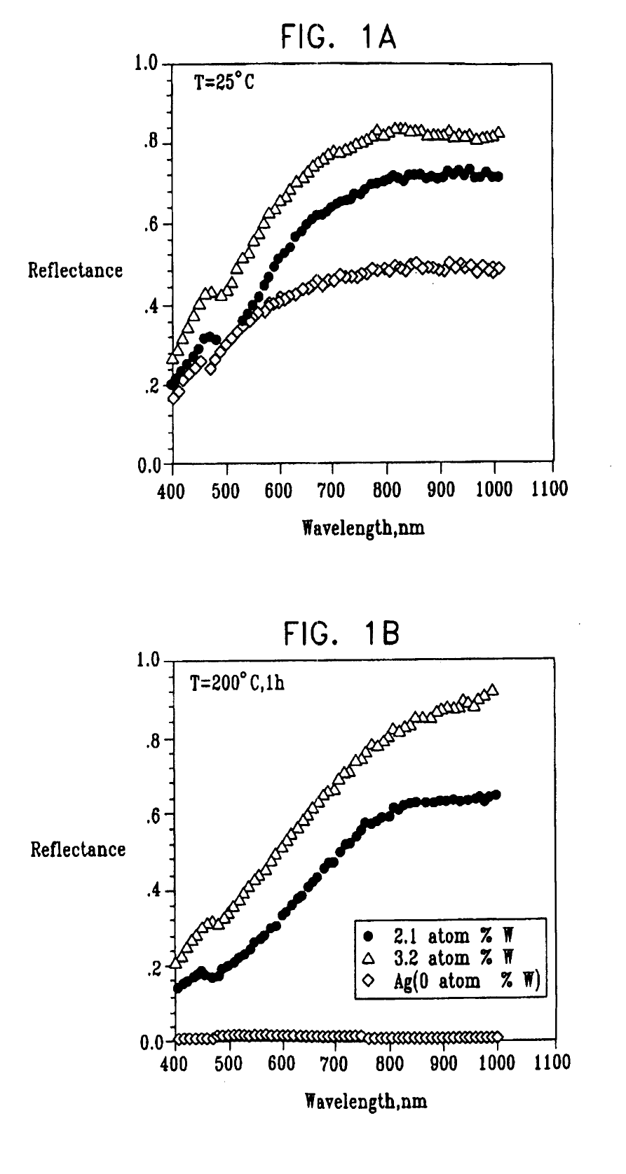

Though electroless solutions, such as in Table 1, have been used in microelectronic applications, it was not known whether large-scale objects would have similar properties. Suprisingly, it was found that large objects were well plated with silver tungsten from such solutions. It was found that silver tungsten plated objects demonstrated far better reflectivity from 400-1100 nm than silver objects. This is shown in FIG. 1a, which is a graph of the reflectance of silver-tungsten coated objects (filled circle, 2.1% tungsten, and unfilled triangle 3.2% atomic percent tungsten) and a pure silver object (unfilled rhombus) as a function of the wavelength of incident light (from 400-1100 nm).

Reference is now made to FIG. 1b, which is a graph of the reflectance of silver-tungsten coated objects (filled circle, 2.1% tungsten, and unfilled triangle 3.2% atomic percent tungsten) and a pure silver object (unfilled rhombus) as a function of the wavelength of incident light after the objects were annealed for one hour in air at 200° C.

The reflectance (R) measurements of the pure silver (0% W) are presented for reference. Adding tungsten to the silver causes R to increase in comparison to the pure silver film. The value of R for the silver tungsten deposits rises with increase of W content and remains greater than that of the silver for all values of incident wavelengths λ. After annealing, the reflectance of the Ag—W films slowly increases (for 3.2 atom % W) or slightly decreases (for 2.1 atom % W), but still remains greater than that of the pure Ag layer. The reflectance of the pure silver film decreases strongly until it almost vanishes (R=0) after the same annealing conditions. The fast silver oxidation and, as a result, the film surface damage under these conditions (formation of silver sulfide, chloride and or oxide) is probably the reason for this phenomenon.

Additional complexing agents (EDTA) and an additive, polyethylene glycol 1500 (PEG 1500) were introduced in the electroless solution (Table 2) to provide a novel bath composition. It was found that this bath composition enabled deposition of a high reflective tarnish resistant silver tungsten deposit on bulk silver.

TABLE 2
THE COMPOSITION OF AN ELECTROLESS AG (W)
DEPOSITION SOLUTION.

| | CONCENTRATION, |
|---|---|
| Component | M |
| AgNO₃ | 0.03 |
| NH₄OH (25%) | 1.22 |
| CH₃COOH | 0.5 |
| N₂H₂ | 0.1 |
| EDTA | (1−1.5) × 10⁻⁵ |
| PEG-1500 | 0.04 |
| Na₂WO₄ | 0.03 |

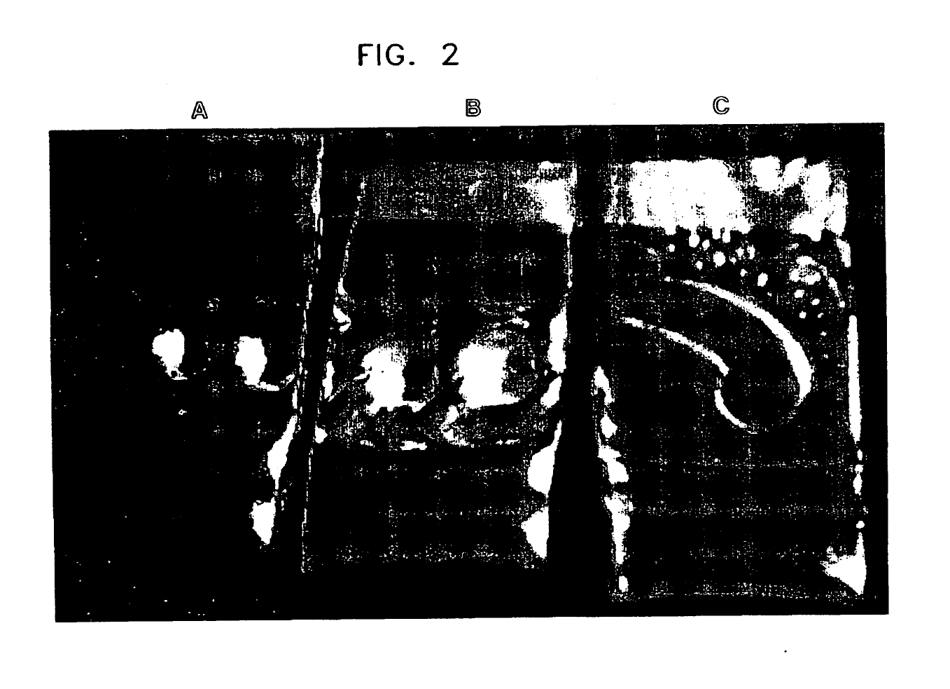

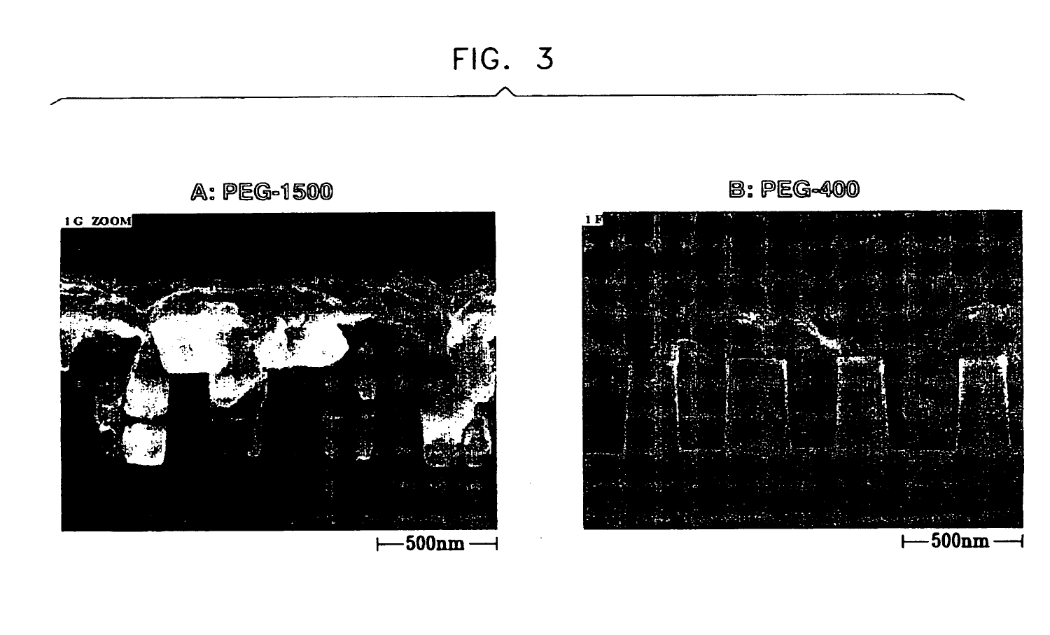

Sterling silver pieces were electrolessly coated in the solution of Table 2, and were covered by silver tungsten (about 3 atom W %). The reflectance of the silver tungsten film covering bulk silver was measured for 250 nm and 500 nm thickness of the film. The visual observation of the surface damage after annealing at 250° C. for 1 hour in air showed no changes in the silver tungsten covered samples brightness and color (with and without ornament), for both thicknesses, in comparison with the non-plated samples (not bright). A standard tarnishing test after 3 hours of exposure at 250° C. has demonstrated the same result: uncovered silver samples were of strong brown color, the thin (250 nm) silver tungsten film coverage was slightly yellow, and no color changes were observed for thick (500 nm) silver tungsten) film coverage. For example, reference is made to FIG. 2a, which is a photographic image of a pure silver object following an accelerated tarnishing test at 250° C. in air for three hours. It can be seen that the silver had tarnished after this test.

Silver objects were plated in the electroless solution of Table 2. In contrast to FIG. 2a, it can be seen that a silver tungsten coated object was only slightly discolored (FIG. 2b). FIG. 2b, shows a photographic image of a silver tungsten coated (250 nm) object following an accelerated tarnishing test at 250° C. in air for three hours.

Additionally, silver objects were plated with electroless solution of Table 2, further comprising 0-0.06 M of molybdic acid monohydrate (H₂ MoO₄.H₂O). A ternary metal coating was produced comprising silver-tungsten-molybdenum.

Another ternary metal complex was made with the electroless solution of Table 2, further comprising 0-0.6 M ammonium perrhenate (APR). A ternary metal coating was deposited comprising silver-tungsten-rhenium. Both the silver-tungsten-molybdenum and silver-tungsten-rhenium deposits demonstrated very good optical and electrical properties. These ternary metal layers did not tarnish nor corrode when exposed to ambient air or to a tarnishing test at 200° C. for three hours in air.

Reference is now made to FIG. 2c, which is a photographic image of a silver tungsten coated (500 nm) object following an accelerated tarnishing test at 250° C. in air for three hours. It can seen that this thick layer of silver tungsten prevented tarnishing on this object, in contrast to the object in FIG. 2a.

Further bath compositions were developed in order to find ways of improving step coverage and filling trenches. One such electroless solution is disclosed in Table 3.

TABLE 3
THE COMPOSITION OF AN ELECTROLESS SILVER
TUNGSTEN DEPOSITION SOLUTION.

| | CONCENTRATION, |
|---|---|
| Component | g/l |
| AgNO₃ | 5.4 |
| Na₂WO₄ | 9.9 |
| N₂H₂ | 3 ml/l |
| EDTA | 15 g/l |
| saccharin | 1 g/l |
| BTA | 0.002 g/l |
| PEG 1500 | 0.01 g/l |
| deposition | 25 min |
| time | |
| temperature | room |
| pH | 11.2 |

It was found that the solution of Table 3 was excellent in filling trenches and for surface coverage.

Reference is now made to FIG. 3a, which is a cross-sectional image of a silver-tungsten coating in trenches, plated from an electroless silver-tungsten solution comprising PEG-1500 (Table 3). It can be seen that the PEG 1500 enabled the electroless solution to fill in trenches with silver tungsten deposit.

Reference is now made to FIG. 3b, which is a cross-sectional image of a silver-tungsten coating in trenches, plated from an electroless silver-tungsten solution comprising PEG-400 (such as in Table 3, but with PEG-400 instead of PEG-1500). The PEG-400 additive was inferior to the PEG-1500 in terms of the quality of the trench coverage.

It was further found that by increasing the tungsten content of the solution (Table 2) to up to 0.6 M sodium tungstate, a high tungsten content silver tungsten coat formed on a silver object (results not shown).

The examples described hereinabove show that these electroless silver-tungsten solutions can be used to deposit silver-tungsten on bulk pure silver and on sterling silver (92.5% silver, 7.5% copper) and improve the corrosion, tarnishing and visual properties thereof. These electroless silver-tungsten solutions are active at room temperature and at moderate alkaline pHs. These solutions can thus be used in a retail store or at home, as well as in industry.

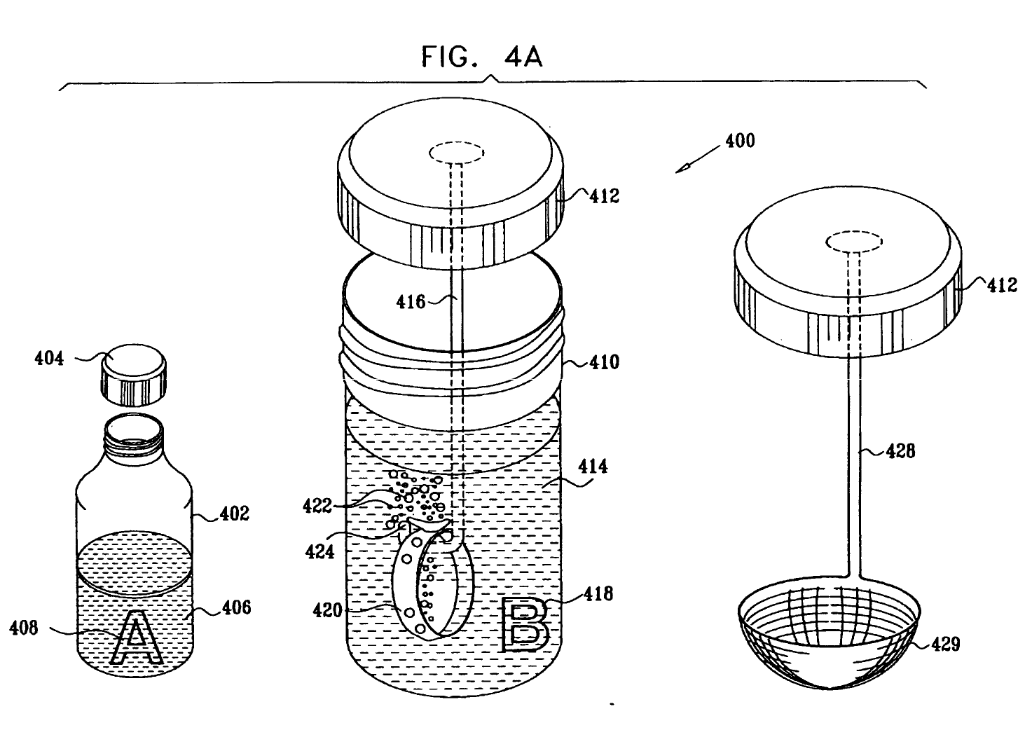

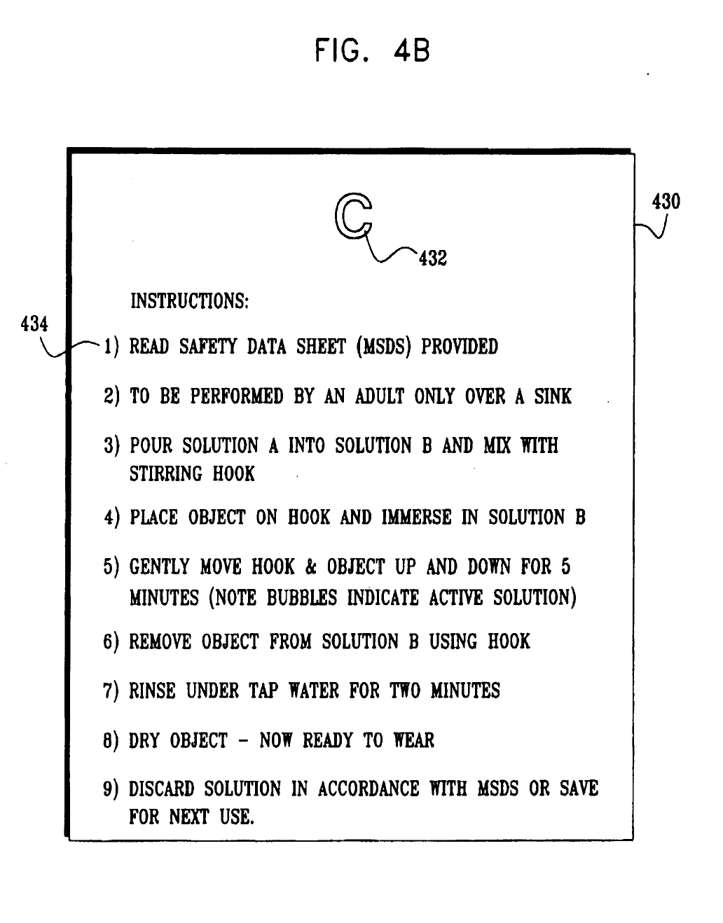

Reference is now made to FIGS. 4a and 4b, which are an exploded schematic illustrations of a kit, 400 for electrolessly plating silver tungsten on a small object.

The kit for use in plating one or more small objects typically comprises a first container 402 with a lid 404. The first container contains an aqueous solution 406 and is labeled with a number or letter 408. The first container is typically a bottle, flask, vial, vessel or the like. The aqueous solution comprises a reducing agent known in the art, such as, but not limited to, hydrazine hydrate. Other reducing agents include sodium borohydride, sodium hypophosphite and dimethylamine borane. The aqueous solution further comprises additives and chelators, such as EDTA, typically at concentrations of 3-5 times those described in Tables 1-3 herein above. Container 402 is typically opaque and is preferably made of colored glass, Teflon, or polypropylene.

Kit 400 further comprises a second container 410 with a screwable lid 412. Container 410 contains a second aqueous liquid 414 and is labeled with a number or letter 418. Lid 412 typically comprises a pole 416, which descends from its lower surface center in parallel and central to the wall of (typically opaque) container 410. This kind of arrangement is similar to a child's blow-soap-bubble container. Pole 416 has a hook 424 at its lower end for holding an object 420 centrally in container 410 in liquid 414. Container 410 is typically two to five times the size of container 402.

In an alternative embodiment, a lid 426, substantially identical to lid 412 has a pole 428 with a sieve 429 at its lower end. The sieve is designed, for example, to hold a number of small objects and/or one or more chains or necklaces.

Typically the second aqueous liquid comprises a silver salt, a tungsten salt, additives such as PEG-1500 and acids, alkalis and buffers for pH control. These components are typically at concentrations of 1-5 times those appearing in Tables 1-3.

Container 410, lids 412, 416, poles 416, 428, hook 424 and sieve 429 are all made of non-metallic materials such as, but not limited to, plastic, colored glass, Teflon, or polypropylene.

Kit 400 further contains an instruction sheet 430, labeled with a number or letter 432. Instruction sheet 430 provides a simple user-friendly set of instructions 434 on how to utilize the kit.

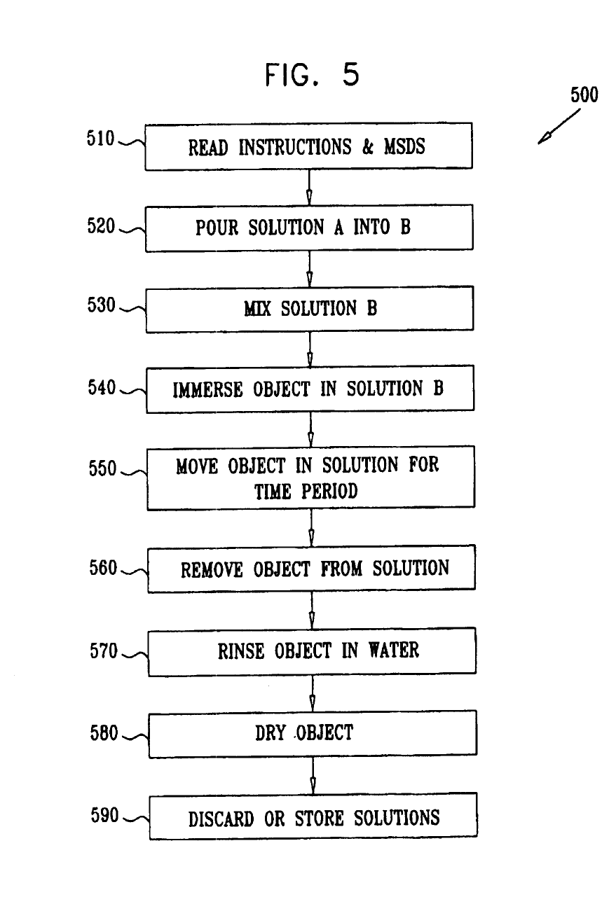

Reference is now made to FIG. 5, which is a flowchart 500 describing the method of employment of the kit of FIGS. 4a and 4b in the steps of electrolessly plating silver tungsten on a small object.

In a first step 510, an operator is instructed to read the instructions 434 appearing on the instructions sheet 430. The operator is also instructed to read the MSDS (manufacturer's safety data sheet), not shown. Instructions 434 comprise simple step by step directions on how to electrolessly plate one or more small objects with silver-tungsten.

In a second step 520, the operator pours some or all of solution “A”, 406 into solution “B”, 414. Preferably both the solutions are used only for one plating process. Alternatively, a proportion of solution A may be retained for one or more additional uses. Container 402 and container 410 may comprise graduated markings for this purpose (not shown). The final concentration of the resultant solution is typically similar or identical to the compositions disclosed in Tables 1-3 hereinabove.

In a mixing step, 530, the operator mixes the solution in container 410 (comprising both solution 406 and 414 in a known ratio).

Thereafter, the operator places an object on hook 424 or in sieve 429 and immerses the object on the hook/in the sieve into the mixed solution in container 410. The mixed solution is typically at room temperature 20-30° C. Though this process is operative at 0-50° C. The pH of the mixed solution is typically 9-11, but the solution is normally operative in a pH range of 8-13, though the reaction rate will vary.

In a deposition step, 550, the operator moves lid 412, and hence the rod, 416 and hook 424 holding the object 420 gently up and down and/or backwards and forwards or a time period. The time period is typically provided in the instructions as a fixed time at room temperature, such as ten minutes. Additionally or alternatively, the instructions may comprise a look-up table, which correlates the deposition time to the process temperature. Bubbles 422 (typically of hydrogen) are indicative that object 420 is being plated by the solution in container 410.

Furthermore, the instructions may provide a rough guide or look-up table for the thickness of silver tungsten that is to be deposited as a function of the surface area of object 420. For example, the surface area [cm²] of a ring can be calculated to be approximately 4Πrh, where r is the radius of the ring and h is the height.

At the end of the given time period, the operator lifts lid 412 vertically and hence removes object 420 from the solution in a removing step 560.

Thereafter, in a rinsing step 570, the operator rinses the object under running tap water. Additionally or alternatively, the rinsing step may comprise dipping the object in a container of water.

In a drying step 580, the operator dries the object with a cloth. Alternatively, the operator leaves the object to dry in ambient air.

In a final step 590, the operator screws lid 412 onto container 410 and stores the solution until its next use in accordance with the instructions, such as in a dark dry place. Additionally, the instructions may indicate that the solution has a longer shelf life if refrigerated between uses.

Alternatively, in step 590, the operator discards the solution in accordance with the instructions and MSDS, such as by pouring down a toilet and flushing the toilet.

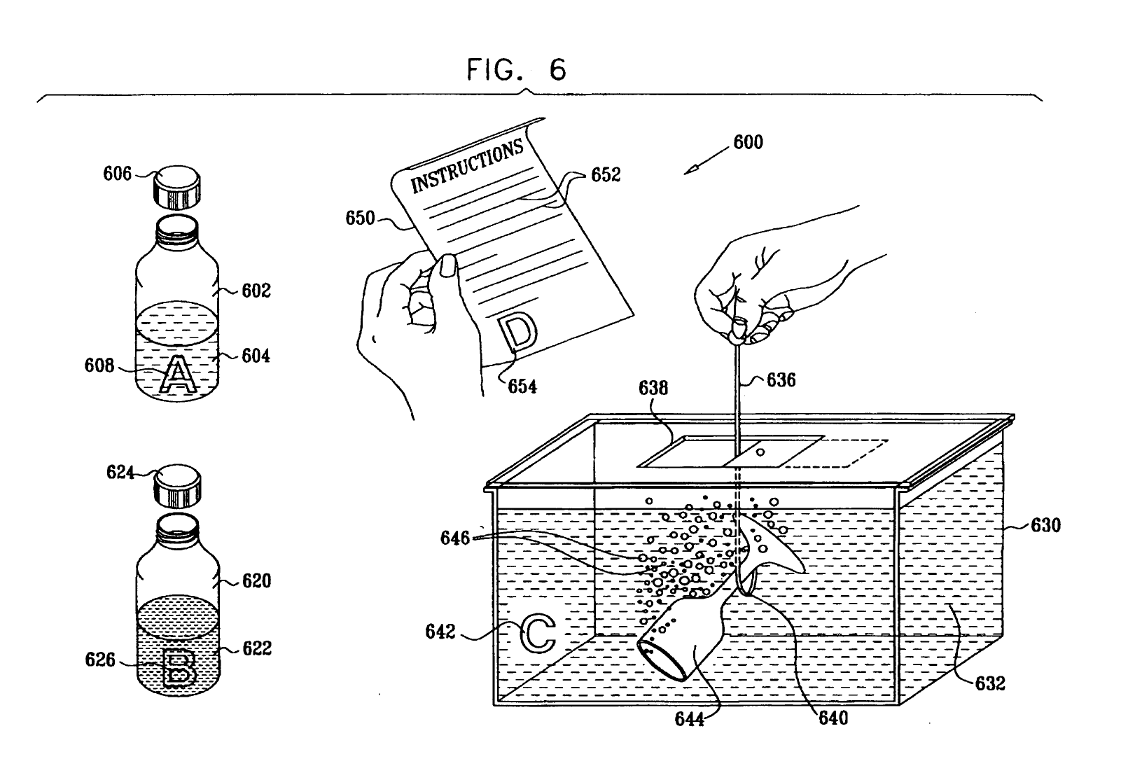

Reference is now made to FIG. 6, which is an exploded schematic illustration of a kit 600 for electrolessly plating silver tungsten on a large object.

Kit 600 differs from kit 400 in that a third container 630 is required and water, preferably distilled water, is added to container 630 in addition to all/part of a first aqueous solution 604—contents of a first container 602 and all/part of a second aqueous solution 622 from container 620.

In an exemplary embodiment, kit 600 comprises container 602, containing the first aqueous solution and having a lid 606 and an alphanumeric label 608.

Container 602 may/may not be substantially similar to container 402 (FIG. 4).

Additionally kit 600, comprises the second container 620 having lid 624 and alphanumeric label 626. Second container 620 may/may not be substantially similar to container 410 (FIG. 4).

Kit 600 further comprises a large container or tank 630 containing water 632. Container 630 has a lid 634. Lid 634 typically comprises an aperture 638, through which a holding rod 636 may be held vertically. Holding rod 636 typically has a loop 640 at its lower end. Alternatively, loop 640 may be replaced by a clasp, clamp, peg or other holding device. Loop 640 is used to hold large object 644. Container 630 typically has an alphanumeric label 642.

The containers, lids, bars and loops of kit 600 are typically of the same non-metallic materials as those described for corresponding parts in kit 400 (FIG. 4).

Rod 636 may be attached to a mechanical moving device, such as an eccentric motor (not shown). In an alternative embodiment, rod 639 may be replaced by a barrel, jig or other holder, known in the art of electrolytic and electroless metal plating. The barrel, jig or other holder may be manually or mechanically operated, as is known in the art.

Kit 600 further contains an instruction sheet 650, labeled with a number or letter 654. Instruction sheet 650 provides a simple user-friendly set of instructions 652 on how to utilize the kit.

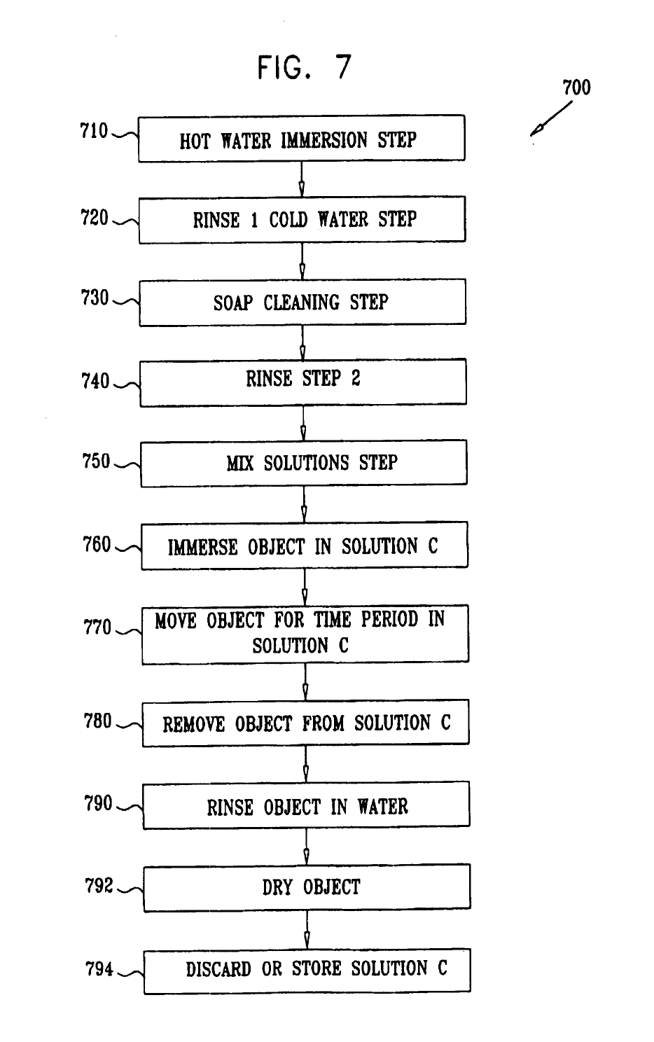

Reference is now made to FIG. 7, which is a flowchart 700 describing the method of employment of the kit of FIG. 6 in the steps of electrolessly plating silver tungsten on a large object.

Typically, large household silver objects require pretreatment, prior to metallic deposition. For example, a candlestick would typically require that all wax be removed therefrom. Thus flowchart 700, describes four steps of pretreatment (steps 710-740) prior to the actual use of kit 600. These steps may be eliminated or replaced by other pre-treatments, depending on the nature of the object and the condition of its surface. In industry, typical pre-treatments include alkaline hot soap dips, such as Top Alclean™ and solvent cleaning stages, as well as water rinses therebetween.

The operator typically reads and or knows instructions 652 on the instructions sheet 650, prior to starting the process. The operator is typically acquainted with the MSDS (manufacturer's safety data sheet), not shown. Instructions 652 comprise simple step by step directions on how to electrolessly plate one or more large objects with silver-tungsten.

In a first pretreatment step 710, the operator immerses object 644 in hot water (40-100° C.) for several minutes to remove dust, dirt and large contaminants from the surface of the object.

In a second pretreatment step 720, the operator manually rinses the object under running tap water.

In a third pretreatment step 730, the operator immerses the object in a hot soapy solution (50-100° C., pH 8-10) in order to remove any further surface contaminants.

The operator then rinses object 644 under running tap water in a fourth pretreatment step (rinse step 2) 740.

In an exemplary embodiment and in accordance with the instructions, the operator fills container 630 with a given volume of water (preferably distilled water). In a mixing step 750, the operator pours the first aqueous solution 604 from the first container 602 into the solution/water 632 in container 630 and mixes the resultant solution with rod 636. The operator further pours the second aqueous solution 622 from second container 620 into container 630 and mixes the resultant solution with rod 636. Preferably both the solutions 604 (“A”) and 622 (“B”) are used only for one plating process.

Alternatively, a proportion of solution A (604) and solution B (622) may be retained for one or more additional uses. Container 602 and container 620 may comprise graduated markings for this purpose (not shown). The ratio of solution A to solution B is normally well-defined and is constant for multiple usage. The final concentration of the resultant solution in container 630 is typically similar or identical to the compositions disclosed in Tables 1-3 hereinabove.

In an immersion step 760, the operator loads the object(s) into loop 640 or onto/into an alternative fixture (peg, barrel, gig, tray sieve, netting) and immerses the loaded object (s) into mixed solution “C” in container 630. The operator may or may not place lid 634 on container 630.

The mixed solution in container 630 is typically at room temperature 20-30° C. Though this process is operative at 0-50° C. The pH of the mixed solution is typically 9-11, but the solution is normally operative in a pH range of 8-13, though the reaction rate will vary.

In a deposition step, 770, the operator moves rod 636 and hence loop 640 holding object 644 gently up and down and/or backwards and forwards for a time period alternatively the object is moved by mechanical means. In another alternative mode, the object is stationary during the deposition step. The time period is typically provided in the instructions as a fixed time at room temperature, such as ten minutes. Additionally or alternatively, the instructions may comprise a look-up table, which correlates the deposition time to the process temperature. Bubbles 646 (typically of hydrogen) are indicative that object 644 is being plated by the solution in container 630.

Furthermore, the instructions may provide a rough guide or look-up table for the thickness of silver tungsten that is to be deposited as a function of the surface area of object 644. For example, the surface area [cm²] of a goblet can be calculated to be approximately 4Πrₐᵥh, where rₐᵥ is the approximate average radius of the goblet and h is the height.

At the end of the given time period, the operator removes lid 636 and further lifts rod 636 vertically and hence removes object 644 from the solution in a removing step 780.

Thereafter, in a rinsing step 790, the operator rinses the object under running tap water. Additionally or alternatively, the rinsing step may comprise dipping the object in a container of water.

In a drying step 792, the operator dries the object with a cloth. Alternatively, the operator leaves the object to dry in ambient air or under a directed hot-air flow.

In a final step 794, the operator closes lid 634 onto container 630 and stores the solution until its next use in accordance with the instructions, such as in a dark dry place. Additionally, the instructions may indicate that the solution has a longer shelf-life if refrigerated between uses.

Alternatively, in step 690, the operator discards the solution in accordance with the instructions and MSDS, such as by shipping out to a chemical waste disposal site.

It should be noted that though kits 400 and 600 are described herein for the electroless plating of silver-tungsten, these types of kits may also be used for electrolessly plating any other metal, metal alloy or metal combination (non-alloy), known in the art. This is with the provision, that the chemicals are not dangerous or toxic (cyanides), requiring the use of a fume cupboard. The electroless solutions preferably operate in a pH range of 3-11.

For example, an electroless gold plating composition, disclosed in U.S. Pat. No. 5,232,492 to Krulik et al., may be used in kit 400 and/or kit 600 to electrolessly plate gold on a large/small object. Commercially available electroless plating solutions known in the art (from, for example, but not limited to, LeoRonal, Freeport N.Y. USA; Shipley Company, LLC, Malborough, Mass., USA; Schloetter Company Ltd., Pershore, UK) for plating a range of metals and metal alloys may be used in kit 400 and/or kit 600 to electrolessly plate the metals or metal alloys on small and/or large objects respectively. Typically, the reducing agent and an optional chelating agent, together with various additives are provided in a first container and metal ions are provided separately in a second container as described for silver-tungsten hereinabove for kits 400 and 600.

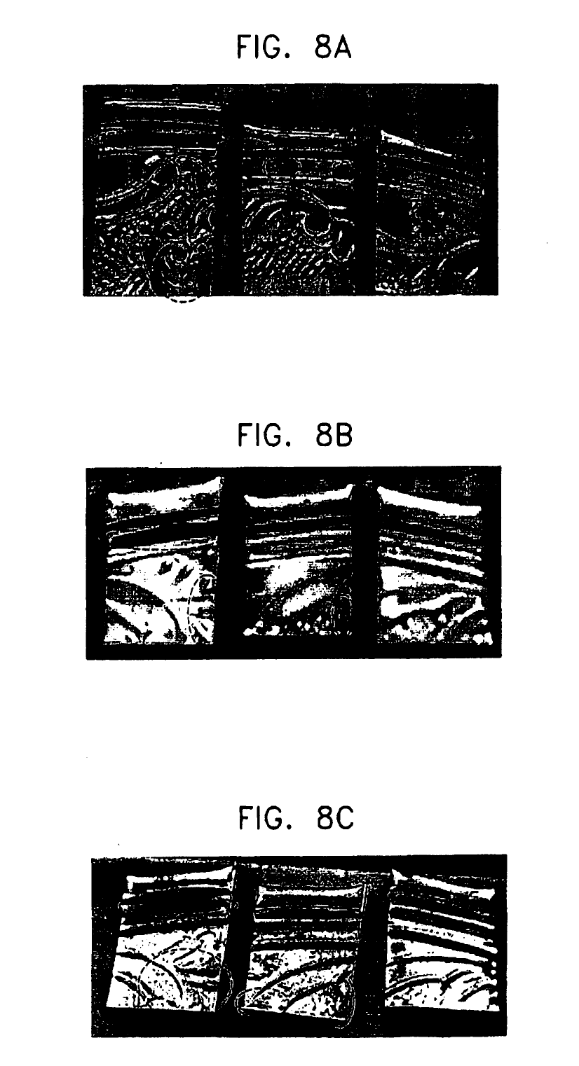

Reference is now made to FIGS. 8A-C, which are images of 1) a piece of bulk silver (left column); 2) a piece of bulk silver with a 300 nm layer of silver tungsten (middle column); and 3) a piece of bulk silver with a 500 nm layer of silver tungsten (right-hand column) after accelerated tests for tarnishing in a sulfur-containing atmosphere.

A solution containing 0.05% of ammonium sulfide in water was introduced in a glass container. Three samples: 1. Sterling bulk silver (on the left), 2. Sterling bulk silver containing on the surface deposited Ag(W) film [Ag(bulk)+Ag(W)film], of a thickness 300 nm (in the middle), 3. Sterling bulk silver containing on the surface deposited Ag(W) film [Ag(bulk)+Ag(W)film], of a thickness of 500 nm (on the right), were placed on the open upper part of container on a grid (films in direction of solution).

After 2 hours, the sterling bulk silver (1) shows clear tarnishing (FIG. 8a). In contrast, sample 2 bulk sterling Ag+Ag(W) of 300 nm thickness, shows low tarnishing and sample 3 (bulk sterling Ag+Ag(W) of 500 nm thickness) remained practically unchanged.

In another experiment, the concentration of ammonium sulfide was increased to 0.2%, and the above protocol was repeated with three samples (as above). It was observed that the sample 1 was strongly tarnished, sample 2 less and sample 3 practically unchanged (FIG. 8b).

Maintaining the same concentration of ammonium sulfide and increasing the time of exposure to 6 hours, similar result were seen:sample 1 high, 2 less and 3 negligible tarnishing, respectively (FIG. 8c).

Taking into account that this is an accelerated test and that in a normal atmosphere the sterling bulk silver reamins untarnished for relative long time (months to years), we can hypothesize that the sample 3 of sterling silver with the 500 nm layer of silver-tungsten should remains untarnished for around ten times the time of the bulk sterling silver.

It should be noted that the terms “reflectivity” and “reflectance” are used herein interchangeably and mean the ratio of energy carried by a wave which is reflected from a surface to the energy carried by the wave which is incident on the surface. The units of reflectivity (ratio) are between zero and one, or may be expressed as a percentage of the reflected energy:incident energy.

It will be appreciated by persons skilled in the art that the present invention is not limited to what has been particularly shown and described hereinabove.

Rather, the scope of the present invention includes both combinations and subcombinations of the various features described hereinabove, as well as variations and modifications thereof that are not in the prior art, which would occur to persons skilled in the art upon reading the foregoing description.

1. A tarnish-resistant coated object comprising:
an object;
a silver-tungsten coating on said object, wherein said silver-tungsten coating has a reflectivity of more than 40% at 700 nm after exposure of said coating to air at 200° C. for a time period of at least one hour.

2-30. (canceled)

31. A tarnish-resistant coated object according to claim 1, wherein said object is selected from an ornamental object, a piece of jewelry, an optical object, a coin, a medal, an electrical object, a kitchen object and a military object.

32. A tarnish-resistant coated object according to claim 1, wherein said object comprises at least one of sterling silvers silver plate and fine silver (100% silver).

33-39. (canceled)

40. A tarnish-resistant coated object according to claim 1, wherein said silver-tungsten coating is provided by electroless deposition from an aqueous composition comprising:
a soluble source of silver ions;
a soluble source of tungsten ions;
a reducing agent; and
at least one additive.

41. A method for providing a tarnish-resistant silver-tungsten coated object comprising:
mixing a first aqueous solution with a second aqueous solution so as to provide an active silver tungsten electroless deposition solution; and
immersing an object in said active electroless deposition solution for a time period sufficient to provide a tarnish-resistant silver tungsten coated object, wherein said tarnish-resistant silver tungsten coated object has a reflectance of more than 0.6 at 700 nm after a time period of at least one hour of exposure of said tarnish-resistant silver tungsten coated object to ambient air.

42. A method according to claim 41, wherein said first solution comprises a reducing agent.

43. A method according to claim 42, wherein said reducing agent is hydrazine hydrate.

44. A method according to claim 41, wherein said first solution comprises a chelator.

45. A method according to claim 44, wherein said chelator is EDTA.

46. A method according to claim 41, wherein said second solution comprises a soluble source of silver ions and a soluble source of tungsten ions.

47. A method according to claim 41, wherein said object is a metallic object.

48. A method according to claim 47, wherein said metallic object is a silver object.

49. A method according to claim 48, wherein said silver object is selected from an ornamental object, a piece of jewelry, an optical object, a coin, a medal, an electrical object, a kitchen object and a military object.

50. A method according to claim 48, wherein said silver object comprises at least one of sterling silver, silver plate and fine silver (100% silver).

51-52. (canceled)

53. A method according to claim 41, wherein said object is a non-metallic object.

54. A method according to claim 52, wherein said non-metallic object comprises at least one of the following materials: a plastic, a polymer, a ceramic material, a cellulose-based material, an inorganic material, an organic material and a fabric.

55. (canceled)

56. A kit according to claim 63, wherein said first aqueous solution comprises a reducing agent.

57. (canceled)

58. A kit according to claim 63, wherein said first aqueous solution comprises a chelator.

59. (canceled)

60. A kit according to claim 63, wherein said second aqueous solution comprises a soluble source of silver ions and a soluble source of tungsten ions.

61-62. (canceled)

63. A kit for providing an electrolessly-deposited metal coated object comprising:
a first receptacle adapted to house a first aqueous solution;
a first aqueous solution;
a second receptacle adapted to house a second aqueous solution and further adapted to house an object;
a second aqueous solution; and
an instruction for:
(i) pouring said first solution into said second solution in said second receptacle so as to provide an active electroless metal deposition solution; and
(ii) immersing the object in said active an active electroless metal deposition solution for a period of time sufficient to provide a metal coated object.

64. An electroless plating composition comprising an aqueous solution for electrolessly plating a surface, comprising:
a soluble source of silver ions;
a soluble source of tungsten ions;
a reducing agent;
at least one additive; and
a polymer adapted to induce filling of at least one of:
a substantially vertical trench of more than 300 nm depth; and
a substantially horizontal gap of more than 200 nm width;
on said surface; and
wherein said plating composition is adapted to electrolessly deposit a corrosion-free conformal layer of silver tungsten on said surface, wherein said layer is from about 0.05 to around 10 microns thick.

65. A composition according to claim 64, wherein said polymer is a polyethylene glycol (PEG).

66-72. (canceled)

73. A tarnish-resistant coated object comprising:
an object;
a silver-tungsten coating on said object, wherein said silver-tungsten coating has a substantially constant reflectivity of more than 90% at 500 nm after exposure of said coated object to ambient air for a time period of at least one week.

74-115. (canceled)

116. An electroless plating composition for preventing discoloration of a metallic object comprising an aqueous electroless plating solution, comprising:
a soluble source of silver ions;
a soluble source of tungsten ions;
a reducing agent;
at least one additive; and
wherein said plating composition is adapted to electrolessly deposit a layer of silver-tungsten on said metallic object so as to provide a silver-tungsten plated metallic object such that said silver-tungsten plated metallic object has less than a 5% increase in light absorbance in a range of incident light at 400-700 nm after exposure to ambient air for a time period of at least one week.

117-129. (canceled)

130. A method for providing a silver ternary metal layer on a surface, comprising:
electrolessly plating said surface in an electroless plating composition for a sufficient time to plate said surface with at least one of a silver tungsten molybdenum layer and a silver tungsten rhenium layer.

131. (canceled)

132. An electroless plating composition, comprising:
a soluble source of silver ions;
a soluble source of tungsten ions;
at least one of a soluble source of molybdenum and a soluble source of rhenium;
a reducing agent; and
at least one additive.

133. (canceled)
